(19) United States
(12) Patent Application Publication
(10) Pub. No.: US 2015/0072685 A1
(43) Pub. Date: Mar. 12, 2015

(54) METHOD OF PERFORMING CELL RESELECTION IN WIRELESS COMMUNICATION SYSTEM HAVING MULTIPLE TYPES OF NETWORKS

(71) Applicant: Acer Incorporated, New Taipei City (TW)

(72) Inventor: Ming-Dao Chuang, New Taipei City (TW)

(21) Appl. No.: 14/331,236

(22) Filed: Jul. 15, 2014

Related U.S. Application Data
(60) Provisional application No. 61/875,709, filed on Sep. 10, 2013.

(51) Int. Cl. H04W 36/24; H04W 36/14

(52) U.S. Cl. CPC H04W 36/245; H04W 36/14
USPC 455/436

(57) ABSTRACT

A wireless communication system includes a user equipment and multiple types of networks. The user equipment stores the cell information of a current cell in a database when the user equipment is camping on the current cell or after the user equipment performs cell reselection to a new cell. The user equipment determines whether inter-RAT cell reselection should be performed according to the system information received from the current cell and the cell information of previous cells stored in its database. Even if the current cell fails to broadcast the accurate and updated information of all neighboring cells, the UE may further check the database periodically or randomly for its previous camping history. Therefore, inter-RAT cell reselection may be properly performed between networks using different RATs in order to reduce call drop rate and improve user experience.

### CROSS REFERENCE TO RELATED APPLICATIONS

This application claims the benefit of U.S. provisional application No. 61/875,709 filed on Sep. 10, 2013.

### BACKGROUND OF THE INVENTION

1. Field of the Invention

The present invention is related to a method of performing cell reselection, and more particularly, to a method of performing inter-RAT cell reselection in the wireless communication system having multiple types of networks.

2. Description of the Prior Art

Wireless communication networks including fixed wireless and cellular-type mobile communications networks continue to evolve. There are several available radio access technologies (RATs) for providing wireless communications including Code Division Multiple Access (CDMA), Time Division Multiple Access (TDMA), Global System for Mobile Communications (GSM), Advanced Mobile Phone System (AMPS) and Digital AMPS (D-AMPS). These networks continue to be deployed throughout the world. Many equipment suppliers currently manufacture these various systems and typically work through standards groups, such as 3rd Generation Partnership Project (3GPP), to ensure commonality and inter-operability of the various networks. Since 1991, GSM/CDMA/AMPS based second generation (2G) networks have been widely used in many parts of the world.

As wireless communications networks move into the 21^{st} century, new types of wireless network are also progressing, such as third generation (3G) networks based on Wideband Code Division Multiple Access (WCDMA), Wideband Packet Code Division Multiple Access (WPCDMA) and Universal Mobile Telecommunications System (UMTS) technologies, or fourth generation (4G) networks based on Worldwide Interoperability for Microwave Access (WiMAX) and Long Term Evolution (LTE) technologies.

When new generation networks are implemented, service coverage may be provided gradually, for example, by migrating slowly from 2G to 3G. Initially, 3G coverage may be limited, with a possibility of drop-outs due to lack of coverage in certain geographical locations. To prevent this, dual-mode wireless mobile terminals capable of operating in both 2G and 3G systems may be provided. It is similar with 3G/4G or 2G/3G/4G operations.

FIG. 1 is a diagram illustrating a prior art wireless communication system 100. A user equipment UE is moving from point P1 to point P6 in a region with UMTS and/or GSM coverage. The hexagons in solid lines represent UMTS cells, and the hexagons in dotted lines represent GSM cells. When camping on a current cell, the UE may obtain knowledge of the public land mobile network (PLMN) identity of the neighboring cells to be considered for cell reselection according to system information broadcast by the current cell. As can be seen in FIG. 1, it is assumed that the UE camps on the UMTS cells U1˜U2 between points P1 and P3 where both UMTS and GSM services are available. Since UMTS service is not available between points P3 and P4, the UE is configured to perform cell reselection after passing point C for camping on the GSM cell G1. Between points P4 and P6, both UMTS and GSM services are available, and the UMTS cell U3 may provide better service than its overlapping GSM cells G1˜G3. As the UE moves from point P4 towards point P6, the signal of the GSM cell G1 may somehow degrade. If the operator of the GSM cell G1 fails to include accurate data of neighboring cells in the system information, the UE is unable to perform cell reselection for camping on the UMTS cell U3, thereby causing call drop. Therefore, there is a need to intelligently perform cell reselection between networks using different RATs in order to reduce call drop rate and improve user experience.

### SUMMARY OF THE INVENTION

The present invention provides a method of performing cell reselection in a wireless communication system. The method includes a user equipment camping on a first cell of a first network using a first RAT; the user equipment receiving first system information from the first cell and storing first cell information associated with neighboring cells of the first cell in a database; and the user equipment determining whether an inter-RAT cell reselection should be performed according to both the first system information received from the first cell and data stored in the database when a predetermined condition is satisfied, or only according to the first system information received from the first cell when the predetermined condition is not satisfied.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a prior art wireless communication system.

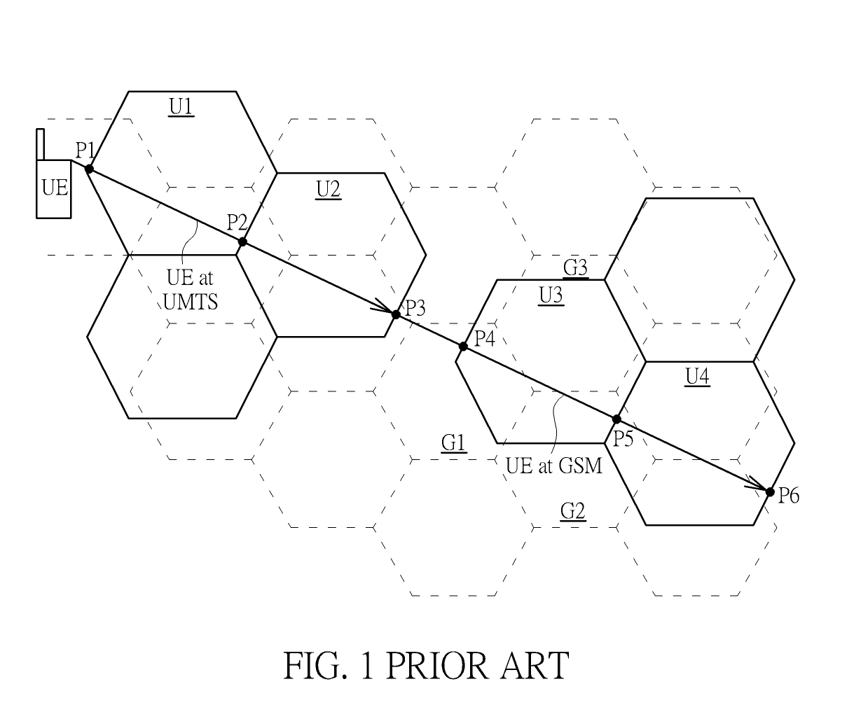

FIG. 2 is a diagram illustrating a wireless communication system having multiple types of networks according to the present invention.

FIG. 3 is a flowchart illustrating a method of performing cell reselection in the wireless communication system in FIG. 2.

### DETAILED DESCRIPTION

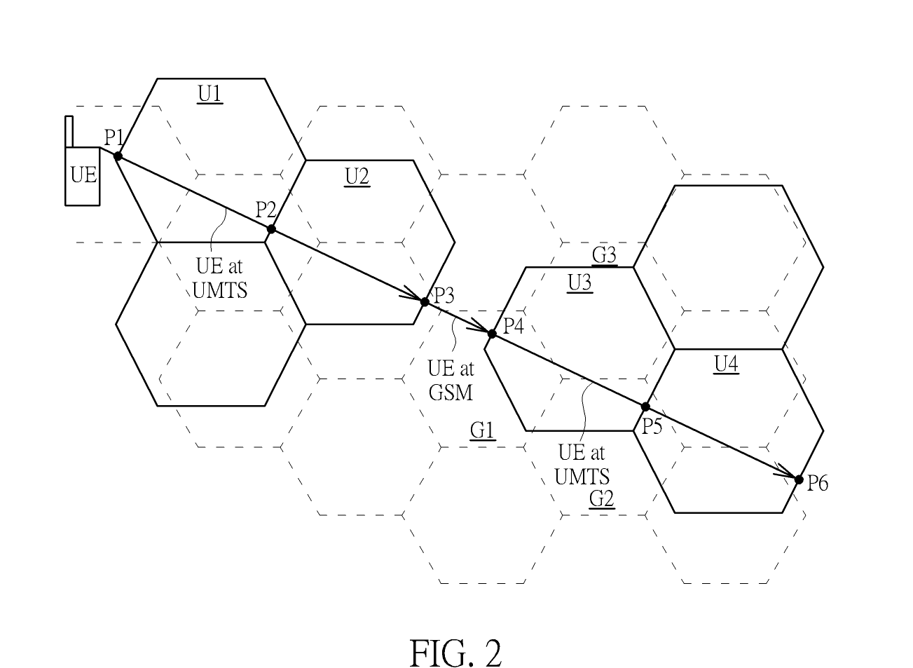

FIG. 2 is a diagram illustrating a wireless communication system 200 having multiple types of networks according to the present invention. In the wireless communication system 200, a user equipment UE is moving from point A to point F in a region wherein networks using different RATS are deployed. For ease of explanation, UMTS and GSM networks are depicted for illustrative purpose, wherein the hexagons in solid lines represent UMTS cells, and the hexagons in dotted lines represent GSM cells.

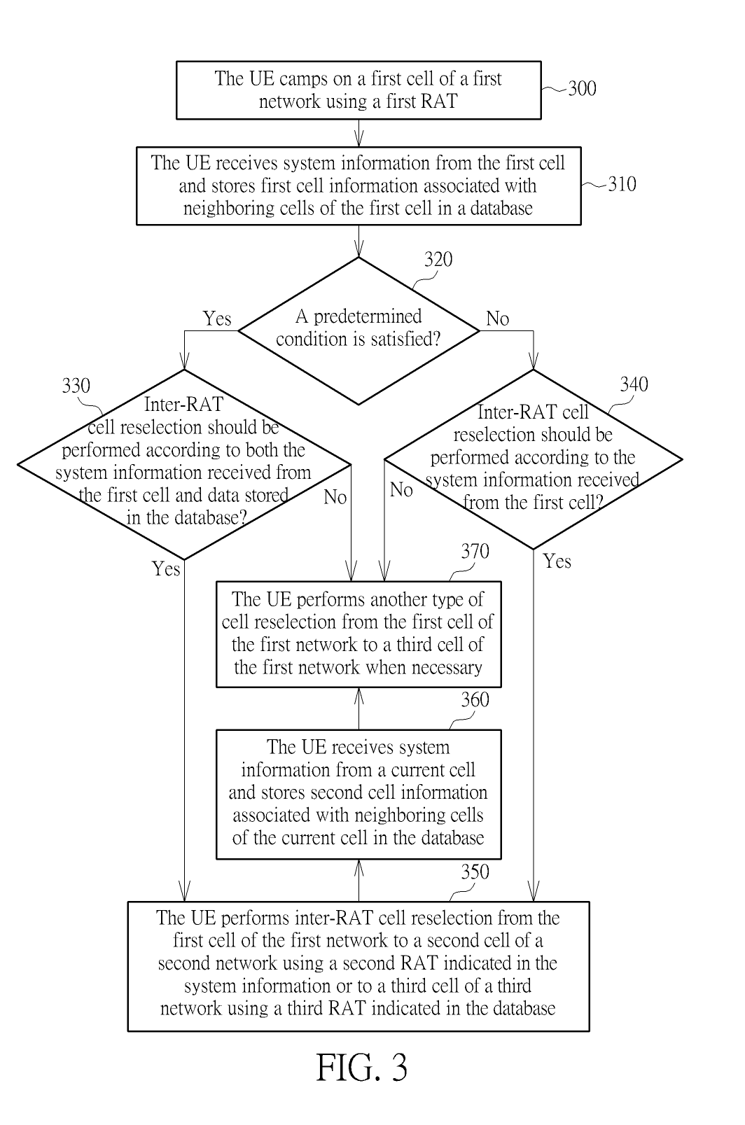

FIG. 3 is a flowchart illustrating a method of performing cell reselection in the wireless communication system 200 and includes the following steps:

Step 300: the UE camps on a first cell of a first network using a first RAT; execute step 310.

Step 310: the UE receives system information from the first cell and stores first cell information associated with neighboring cells of the first cell in a database; execute step 320.

Step 320: the UE determines whether a predetermined condition is satisfied; if yes, execute step 330; if no, execute step 340.

Step 330: determine whether inter-RAT cell reselection should be performed according to both the system information received from the first cell and data stored in the database; if yes, execute step 350; if no, execute step 370.

Step 340: determine whether inter-RAT cell reselection should be performed only according to the system information received from the first cell; if yes, execute step 350; if no, execute step 370.

Step 350: the UE performs inter-RAT cell reselection from the first cell of the first network to a second cell of a second network using a second RAT indicated in the system information or to a third cell of a third network using a third RAT indicated in the database; execute step 360.

Step 360: the UE receives system information from a current cell and stores second cell information associated with neighboring cells of the current cell in the database; execute step 370.

Step 370: the UE performs another type of cell reselection from the first cell of the first network to a fourth cell of the first network when necessary.

In step 300, it is assumed that the UE is currently camping on the first cell of the first network using the first RAT. The first network may be any type of 2G/3G/4G networks using a corresponding RAT.

In step 310, the UE is configured to receive the system information when camping on the first cell and stores the first cell information associated with neighboring cells of the first cell in the database. The system information contains network parameters broadcast by the first network via broadcast control channel (BCCH). The BCCH is a point-to-multipoint and downlink channel which carries a repeating pattern of network identity parameters, cell selection parameters, system control parameters and network function parameters. The system information describes the identity, configuration and available features of the base transceiver station (BTS) in the current network, and also provides a list of absolute radio-frequency channel numbers (ARFCNs) used by other BTSs in the neighboring networks. By reading the system information, the UE can access the current network, perform cell reselection, fully utilize various services provided by the current network, and achieve favorable cooperation with the current network.

The first cell information may be related to the type of RAT, the frequency band and/or the carrier number used by one or more neighboring cells of the first cell. In an embodiment of the present invention, the first cell information may include information about the RAT used by a cell which the UE used to camp on, and may be stored in the data base in the following forms “LTE Band3 EARFCN 1850” or “UMTS Band1 UARFCN 10762”. UARFCN stands for UTRA absolute radio frequency channel number, wherein UTRA stands for UMTS terrestrial radio access. EARFCN stands for EUTRA absolute radio-frequency channel number, wherein EUTRA stands for evolved UMTS terrestrial radio access. UARFCN is used to identify a frequency in the UMTS frequency bands, while EARFCN is used to identify a frequency in the LTE frequency bands. However, the form of the first cell information does not limit the scope of the present invention.

In step 320, the predetermined condition is considered to be satisfied when a timer expires. When the predetermined condition is satisfied, step 330 is then executed in which the determination of whether inter-RAT cell reselection should be performed is based on both the system information received from the first cell and the data stored in the database. When the predetermined condition is not satisfied, step 340 is then executed in which the determination of whether inter-RAT cell reselection should be performed is based on the system information received from the first cell only.

If the first cell adopts GSM technology, the UE is configured to check the type 2ter and the type 2quater in the system information in step 330 or 340; if the first cell adopts UMTS technology, the UE is configured to check the block 19 in the system information in step 330 or 340.

According to the 3GPP specification TS 44.018, the system information type 2ter is sent optionally on the BCCH by the network to all mobile stations within the cell giving information on the extension of the BCCH allocation in the neighboring cells, and the system information type 2quater is sent optionally on the BCCH by the network to all mobile stations within the cell giving information on additional measurement and reporting parameters and/or UTRAN neighboring cells and/or E-UTRAN neighboring frequencies and/or closed subscriber group (CSG) neighboring cells. According to the 3GPP specification TS 25.331, the system information block type 19 contains inter-RAT frequency and priority information to be used in neighboring cells.

In the ideal case, the UE can obtain the information of all neighboring cells according to the system information received from its current cell. However, in the situation that the current cell fails to broadcast the accurate and updated information of all neighboring cells, the UE may further check the database in the present invention.

As previously illustrated, the database contains information about one or more RATs used by one or more cells which the UE has camped on recently. If a specific RAT is indicated in the database, it is very likely that a neighboring cell also uses the specific RAT, even if this information is not included in the system information. In an embodiment, the timer for determining whether the predetermined condition is satisfied in step 320 may be reset immediately after its expiry. That is, the UE is configured to periodically use the data stored in the database for determining whether inter-RAT cell reselection should be performed. In another embodiment, the timer may be reset after each time any cell information stored in the database is used. That is, the UE is configured to randomly (with a certain probability) use the data stored in the database for determining whether inter-RAT cell reselection should be performed.

In step 330 or 340, the UE may perform inter-RAT measurement as specified in the 3GPP specification TS 25.331 for determining whether a handover from a currently-camped cell to another cell should be performed. Inter-RAT measurement includes 4 reporting events defined as follows:

Event 3A: the estimated quality of the currently used UTRAN frequency is below a certain threshold and the estimated quality of the other system is above a certain threshold.

Event 3B: the estimated quality of other system is below a certain threshold.

Event 3C: the estimated quality of other system is above a certain threshold.

Event 3D: change of best cell in other system.

The UE may report any of the events 3A˜3D to the first cell if the corresponding criteria are satisfied. If it is determined that inter-RAT cell reselection should be performed according to the reported events, the first cell is configured to instruct the UE to handover from the first cell of the first network to the second cell of the second network using the second RAT indicated in the system information or to the third cell of the third network using the third RAT indicated in the database in step 350. The second network or the third network may be any type of 2G/3G/4G networks, and the second or third RAT is different from the first RAT used by the first network.

In step 360, the second cell information may be related to the type of RAT, the frequency band and/or the carrier number used by one or more neighboring cells of the current cell (the second cell or the third cell). However, the form of the second cell information does not limit the scope of the present invention.

In step 370, the UE may perform other types of measurement as specified in the 3GPP specification TS 25.331 in order to determine whether other types of cell reselection should be performed. For example, the UE may perform any of the intra-frequency measurements, inter-frequency measurements, traffic volume measurements, quality measurements, UE internal measurements, and UE positioning measurements as defined in the 3GPP specification TS 25.331.

In the present invention, the UE may include transportable electronic devices, such as mobile telephones, personal digital assistants, handheld, tablet, nettop, or laptop computers, or other devices capable of operating in two or more types of networks including 2G/2.5G/2.75G/3G/4G. The 2G GSM cells and the 3G UMTS cells depicted in FIG. 2 are only for illustrative purpose, and do not limit the scope of the present invention.

In the present invention, steps 300˜370 may be repeated performed so that the UE may determine whether inter-RAT cell reselection should be performed according to the system information received from the current cell and further according to the cell information of previous cells stored in its database periodically or randomly. Even if the currently-camped cell fails to broadcast the accurate and updated information of all neighboring cells, the UE may further check the database for its previous camping history. Therefore, inter-RAT cell reselection may be properly performed between networks using different RATs in order to reduce call drop rate and improve user experience.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of performing cell reselection in a wireless communication system:
a user equipment camping on a first cell of a first network using a first radio access technology (RAT);
the user equipment receiving first system information from the first cell and storing first cell information associated with neighboring cells of the first cell in a database; and
the user equipment determining whether an inter-RAT cell reselection should be performed according to both the first system information received from the first cell and data stored in the database when a predetermined condition is satisfied, or only according to the first system information received from the first cell when the predetermined condition is not satisfied.

2. The method of claim 1, further comprising:
the user equipment performing the inter-RAT cell reselection from the first cell to a second cell of a second network using a second RAT indicated in the first system information when it is determined that the inter-RAT cell reselection should be performed; and
the user equipment receiving second system information from the second cell and storing second cell information associated with neighboring cells of the second cell in the database.

3. The method of claim 1, further comprising:
the user equipment performing the inter-RAT cell reselection from the first cell to a third cell of a third network using a third RAT indicated in the database when it is determined that the inter-RAT cell reselection should be performed; and
the user equipment receiving third system information from the third cell and storing third cell information associated with neighboring cells of the third cell in the database.

4. The method of claim 1, further comprising:
activating a timer;
determining that the predetermined condition is satisfied when the timer expires; and
resetting the timer immediately after the timer expires.

5. The method of claim 1, further comprising:
activating a timer;
determining that the predetermined condition is satisfied when the timer expires; and
resetting the timer after each time any cell information stored in the database is used.

6. The method of claim 1, wherein the first cell information include a type of RAT, a frequency band and/or a carrier number used by one or more neighboring cells of the first cell.

7. The method of claim 1, wherein the first system information include an absolute radio-frequency channel number (ARFCN) used by a base transceiver station (BTS) in a neighboring network of the first network.

8. The method of claim 1, wherein the first RAT used by the first cell is a Global System for Mobile Communications (GSM) technology, and the user equipment determining whether the inter-RAT cell reselection should be performed comprises:
the user equipment determining whether a second network using a second RAT is indicated in a type 2ter and a type 2quater of the first system information defined in a 3rd Generation Partnership Project (3GPP) specification TS 44.018.

9. The method of claim 1, wherein the first RAT used by the first cell is a Universal Mobile Telecommunications System (UMTS) technology, and the user equipment determining whether the inter-RAT cell reselection should be performed comprises:
the user equipment determining whether a second network using a second RAT is indicated in a block 19 of the first system information defined in a 3GPP specification TS 25.331.
